(19) United States
(12) Patent Application Publication
(10) Pub. No.: US 2017/0169358 A1
(43) Pub. Date: Jun. 15, 2017

(54) IN-STORAGE COMPUTING APPARATUS AND METHOD FOR DECENTRALIZED MACHINE LEARNING

(71) Applicant: SAMSUNG ELECTRONICS CO., LTD., Suwon-si (KR)

(72) Inventors: Inseok Stephen CHOI, Redwood City, CA (US); Yang Seok KI, Palo Alto, CA (US)

(21) Appl. No.: 15/040,954

(22) Filed: Feb. 10, 2016

Related U.S. Application Data
(60) Provisional application No. 62/265,192, filed on Dec. 9, 2015.

(51) Int. Cl. G06N 99/00; G06F 17/30

(52) U.S. Cl. CPC G06N 99/005; G06F 17/30867

(57) ABSTRACT

A storage device includes a processor, a storage and a communication interface. The storage is configure to store local data and a first set of machine learning instructions, and the processor is configured to perform machine learning on the local data using the first set of machine learning instructions and generate or update a machine learning model after performing the machine learning on the local data. The communication interface is configured to send an update message including the generated or updated machine learning model to other storage devices.

### CROSS-REFERENCE TO RELATED APPLICATION(S)

This application claims the benefit of and priority to U.S. Provisional patent application Ser. No. 62/265,192 filed Dec. 9, 2015 , the disclosure of which is incorporated herein by reference in its entirety.

### TECHNICAL FIELD

The present disclosure relates generally to computing apparatus for machine learning and, more particularly, to in-storage computing apparatus and method for decentralized machine learning.

### BACKGROUND

The Internet of Things (IoT) refers to a distributed network connecting “things” (or physical devices) embedded with computing resources such as electronics, software, sensors, and network connectivity. IoT enables the “things” (also referred to as IoT devices) to sense, collect, and exchange data with each other across an existing network infrastructure (e.g., the Internet) while providing integration between the physical world and computer-based systems. The “things” can refer to a wide variety of devices such as webcams, security cameras, surveillance cameras, thermostats, heart rate monitors, smart appliances, smart cars, field operation devices, and various sensors.

Typically, IoT devices collect different types of information and send the collected information to a centralized server for centralized data storage, processing, and analysis. Traditional machine learning from the compilation of collected data by IoT devices is limited by several technical, capital, and legal concerns. For example, deep learning (a subject of machine learning) requires a central server having high computing and storage capacity for capturing, storing, and sharing large amounts of data. The communication infrastructure should also have high bandwidth to allow the exchange of large amount of data between the IoT devices and the server. In addition, there are privacy and legal issues regarding the control, storage, management, and distribution of the collected data by IoT devices. Further, in traditional machine learning, the central server is responsible for most of the computation, analysis, and exchange of data, the storage and access of the data, and learned results in storage devices on top of other overhead duties.

### SUMMARY

According to one embodiment, a storage device includes a processor, a storage and a communication interface. The storage is configure to store local data and a first set of machine learning instructions, and the processor is configured to perform machine learning on the local data using the first set of machine learning instructions and generate or update a machine learning model after performing the machine learning on the local data. The communication interface is configured to send an update message including the generated or updated machine learning model to other storage devices.

According to one embodiment, a method includes: storing local data and a first set of machine learning instructions in a storage device; performing machine learning on the local data using the first set of machine learning instructions; generating and updating a machine learning model; and sending an update message including the generated or updated machine learning model to other storage devices.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1A shows a conceptual diagram of a prior art centralized machine learning system;

FIG. 1B shows a conceptual diagram of a decentralized machine learning system with the present machine learning device, according to one embodiment;

FIG. 2 shows a diagram of an example decentralized machine learning system, according to one embodiment;

FIG. 3 shows an example of a decentralized machine learning process by the present machine learning device, according to one embodiment;

FIG. 4 is an example flowchart for processing new data, according to one embodiment;

FIG. 5 is an example flowchart for processing new updated training data, according to one embodiment;

FIG. 6 is an example flowchart for processing new algorithm, according to one embodiment;

FIG. 7 is an example flowchart for data search, according to one embodiment; and

FIG. 8 is an example diagram explaining communication between storage devices, according to one embodiment.

The FIGS. are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a smart device for decentralized machine learning. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The required structure for a variety of the disclosed devices and systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

As discussed in the background section, traditional machine learning by a central server can have various issues and concerns when being implemented in a distributed network system such as an IoT system. For example, legal and privacy issues may arise surrounding the ownership, authorization, control, and distribution of the underlying data collected by IoT devices. Some private data may require protection or proper authorization for copy and distribution to other devices. Some data maybe freely copied and transferred to a server for centralized data processing and analysis if the data represents abstraction information of the private data (e.g., image tags).

A smart solid-state drive (SmartSSD, herein also referred to as a smart device or a machine learning storage device) refers to a device that has a storage and a computing (or machine learning) capability implemented therein. Examples of such smart devices include, but are not limited to webcams, baby monitors, surveillance cameras, security cameras, autonomous car cameras, dash cameras, back-up cameras, drones, smart watches, thermostats, heart rate monitors, pedometers, smart appliances, smart cars, field operation devices, and various types of sensors distributed over a wide range of area (sensor area network, SAN). The computing capability of the smart device can enable distributed machine learning at a device level, as opposed to a conventional machine learning scheme that is dedicated to a centralized server. According to some embodiments, a plurality of smart devices can decentralize and improve the performance of the machine learning system capability while resolving legal, privacy, and cost issues that may arise with conventional centralized machine learning. The present decentralized machine learning system including a plurality of smart devices can extract abstract information from data that are locally generated and send the abstract information to other trusted smart devices instead of sending the raw and unprocessed data to a central server. Since the present decentralized machine learning system can utilize existing local computing resources for the decentralized machine learning process, the cost of system implementation, operation, and maintenance can be reduced, and a central server that would otherwise see heavy usage of data distribution and processing can be utilized for more high-level deep learning using the locally (thus decentralized) learned and trained data.

Deep learning (also referred to as deep machine learning) is a subject of machine learning that attempts to model high-level abstractions represented by data using multiple processing layers, or otherwise including multiple non-linear transformations of data. For example, an image captured by a camera can be represented in many ways such as a vector of intensity values per pixel, or in a more abstract way as a set of edges, regions of particular shape, etc. Some representations of data make it easier to learn tasks (e.g., face recognition or facial expression recognition) from examples of other images or training data. Deep learning can replace handcrafted feature learning such as manual tagging with efficient algorithms for unsupervised or semi-supervised feature learning and hierarchical feature extraction from the received raw data. While deep learning is getting popular, the implementation of a decentralized application for machine learning is not trivial.

The present disclosure provides a smart device that is capable of distributed machine learning independently from or in conjunction with other smart devices and/or a host/client computer.

According to one embodiment, the present smart device can include various computing resources such as an onboard processor, a memory, and a data storage for storing raw data, training data, trained data with label(s), trained label indices, and learning algorithms. The learning algorithms can include self-learned algorithms and algorithms received from other smart devices or the host/client computer. The present smart device can also collect different type of surrounding information using an embedded sensor. For example, a smart watch can include one or more sensors such as a heartrate sensor, a pedometer sensor, an accelerometer, and a glucose sensor for monitoring a user's heartbeat, movement, electrodermal activity, and a glucose level, etc. The present smart device can determine and classify, by employing machine learning, the user's baseline condition or an abnormal condition. Other examples of an embedded sensor include, but are not limited to, an image sensor (or a camera), a temperature sensor, a humidity sensor, and an occupancy sensor. In other embodiments, the present smart device can connect with an external sensor instead of having an embedded sensor. The computing capability of the present smart device can offload machine learning that is otherwise processed by a central server to process raw data and generate training and trained data (e.g., image tags). The smart device can also include communication mechanism (e.g., messages for teach, alarm, exchange) to communicate with other smart devices, and/or the host/client computer.

For decentralized machine learning, the onboard processor of the present smart device can have computing resources and power to perform decentralized machine learning. The data storage can include a non-volatile memory such as a flash memory, a phase-change memory (PCM), a spin-transfer torque magnetic RAM (STT-MRAM), or the like. The memory can be a volatile memory such as dynamic random access memory (DRAM). In some embodiments, the onboard processor can be on the same die as the memory and/or data storage for efficient data exchange and analysis. Compared to a host processor of a traditional machine learning system that is typically coupled with a “dumb” storage device (or system) and communicates over a storage infrastructure (e.g., Peripheral Component Interconnect Express (PCIe) bus), the present smart device can have an in-device and on-die communications bandwidth that is much higher than that of the storage infrastructure of the traditional machine learning system. Furthermore, the onboard processor of the present smart device may require less overhead to track and maintain data, and hence be able to perform machine-learning activities more efficiently. The decentralized machine learning can free up the host processor and utilize the host processor to perform more useful and higher-level deep machine learning activities.

According to some embodiments, the present smart device can receive learning instructions and data, apply the received instructions to the data, and provide learning results based on the learning instructions to a recipient. The recipient can be either a host computer, a client computer, a data storage, or another smart device for further processing. The present smart device has data input and output (I/O) capabilities that allows for more useful and efficient data exchange with the recipient. Since the present device can perform computations on its own, less of its I/O capabilities can be dedicated to receiving and responding to host requests, and more of its I/O capabilities can be used for receiving more useful data and/or transmitting more useful results to other recipients. Some smart devices can have only data output capabilities for transmitting data (e.g., sensors) while some other smart devices can have both data input and output capabilities. It is noted that terms, smart devices and (decentralized) machine learning devices, can be interchangeably used unless otherwise specifically indicated.

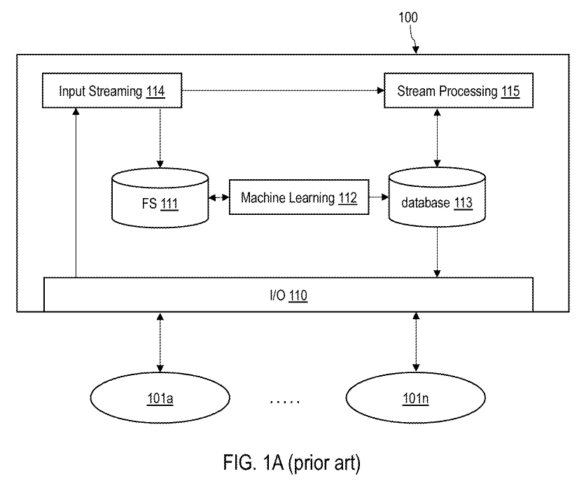

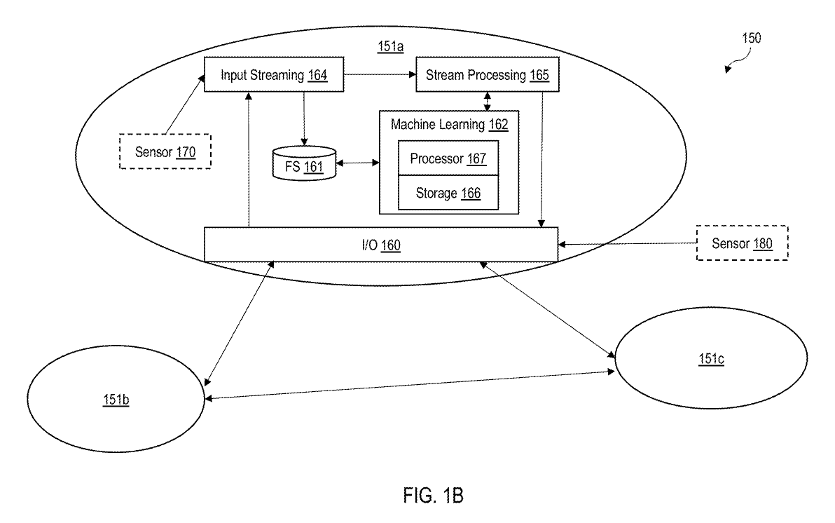

FIG. 1A shows a conceptual diagram of a prior art centralized machine learning system. The central server 100 can have an I/O interface 110 (e.g., Ethernet) that is configured to communicate with devices 101a-101n. The devices 101a-101n can be sensing devices or standalone computer nodes. Data generated by the devices 101a-101n are received at the I/O interface 110 of the central server 100 and streamed to an input streaming module 114. The input streaming module 114 can send the stream data to a file system 111 for data storage as well as to a stream processing module 115 for further data processing. The stream data can be stored as raw data or compressed data in the file system 111. The data saved in the file system 111 can be further encrypted with an encryption key. The encrypted data can be shared with other devices that has a matching decryption key.

The stream processing module 115 can process the stream data received from the input streaming module 114 and generate records indicating an event identified by the stream data such as an alarm. The stream processing module 115 can process the stream data in parallel while the input streaming module 114 saves the stream data to the file system 111. For example, the stream processing module 115 can process an image generated by a security camera and generate an alarm in parallel. For example, the alarm can be sent via an output port to a designated device (e.g., a smartphone) or a user (e.g., a homeowner, or a security company) in the form of a notification message. The stream processing module 115 can save the processed data to a database 113. In one embodiment, the database 113 can be an Apache HBase® or NoSQL database, although the type of the database 113 is not limited thereto.

The central server 100 can further include a machine learning module 112 that is coupled to the file system 111 and the database 113. The machine learning module 112 can perform various types of machine learning activities. Examples of machine learning activities can include, but are not limited to, tagging and analysis on the input stream data. The processed data by the stream processing module 115 and the machine learning module 112 can be saved to the database 113. The database 113 can be a key-value (KV) database and store an associative array (e.g., a map, a dictionary) to represent data as a collection of key-value pairs. The saved data in the database 113 can be made available to an external system (not shown) that is authorized to access a particular piece of data stored in the database 113.

The machine learning module 112, the input streaming module 114, and the stream processing module 115 of the central server 100 can be implemented in software or firmware. The instructions of the software or the firmware can be stored in a local storage (not shown) and processed by a processor of the central server 100. The instructions of the software or the firmware can be updated from an external system or the machine learning module 112 internally. The learned results can be stored in the database 113. For example, the streaming processing module 115 can have a facial recognition capability and further refer to the registered facial models stored in the database 113. When identifying facial images from the images received from a security camera, the stream processing module 115 can distinguish faces of unregistered users from faces of registered users and generate alarms accordingly. In some embodiments, the stream processing module 115 can further process streaming images to classify suspicious conducts by recognizing a face and behaviors of a suspect.

The machine learning module, 112, the input streaming module 114, and the stream processing module 115 of the central server 100 can be implemented in hardware, and each of the hardware can have dedicated computing resources. For, each processor in a multicore system can be configured to perform designated tasks for the input streaming module 114, and the stream processing module 115. In this case, the processors of the multicore system can communicate with each other via shared memory that is much more efficient than inter-process communication (IPC).

FIG. 1B shows a conceptual diagram of a decentralized machine learning system with the present machine learning device, according to one embodiment. The decentralized machine learning system 150 can include a plurality of machine learning devices 151a-151c. Although the present example shows only three machine learning devices 151a-151c, it is understood that decentralized machine learning system 150 can have any number of machine learning devices 151. Each of the machine learning devices 151a-151c can include a machine learning module 162, an input streaming module 164, a stream processing module 165, and a file system 161, and an I/O interface 160.

Compared to the example of a centralized machine learning scheme illustrated with respect to FIG. 1A, the decentralized machine learning system 150 does not require a central server 100 for collecting data from various devices and performing machine learning in a centralized manner. However, it is noted that the decentralized machine learning system 150 can also have one or more server systems (not shown) for collective deep machine learning that may require cumulative data received from multiple machine learning devices 151 over a certain period of time.

According to one embodiment, the machine learning devices 151a-151c can share some similar components. Examples of the shared components can include, but are not limited to, a processor, a memory, a local storage, and a communication interface. Examples of the functional components can include, but are not limited to, an input/output (I/O) interface, a decentralized machine learning module, and a mechanism to receive and send trained results to and from other machine learning devices 151.

According to one embodiment, each of the machine learning devices 151a-151c can be the same type of device (e.g., cameras) of different kinds. For example, the machine learning device 151a can be a security camera, the machine learning device 151b can be a webcam, and the machine learning device 151c can be a baby monitor. In another embodiment, the machine learning devices 151a-151c may be dissimilar devices. For example, the machine learning device 151a can be a refrigerator, the machine learning device 151b can be a thermostat, and the machine learning device 151c can be a security camera. It is understood that any type of machine learning devices can be used in conjunction with other machine learning devices without deviating from the scope of the present disclosure.

The I/O interface 160 of the machine learning device 151a can be configured to facilitate communication with other the machine learning devices 151b and 151c and with any host/client server. The machine learning device 151a can include an embedded sensor 170 (e.g., an image sensor (camera), a temperature sensor, a humidity sensor, an occupancy sensor, etc.) or an external sensor 180 may be coupled with the machine learning device 151a. Using the embedded and/or external sensor, the machine learning device 151a can generate data. The machine learning device 151a can further send the self-generated data to and receive data (e.g., taught data, alarms) from other machine learning devices via the I/O interface 160. The data can be streamed to an input streaming module 164. The input streaming module 164 can send the stream data to a file system 161 for data storage as well as to a stream processing module 165 for further data processing. The stream data can be stored as raw data or compressed data in the file system 161. The data saved in the file system 161 can be further encrypted for privacy and security using an encryption key.

The stream processing module 165 can process the stream data received from the input streaming module 164 and generate records indicating an event such as an alarm. The stream processing module 165 can process the stream data in parallel when the input streaming module 164 saves the stream data to the file system 161. For example, the stream processing module 165 can process an image generated by a security camera and generate an alarm. The alarm can be sent via an output port to a designated device (e.g., a smartphone) or a user (e.g., a homeowner, or a security company) in the form of a message over a communication network (e.g., the Internet).

The machine learning module 162 can be coupled to the file system 161. The machine learning module 162 can perform various types of machine learning tasks. Examples of machine learning tasks can include, but are not limited to, tagging and analysis on the input image data. The processed data by the stream processing module 165 can be sent to other machine learning devices 151 or a server for further and deeper processing and storage. According to one embodiment, the processed data from the machine learning devices can be sent to a central database (not shown) or a local database of the machine learning device 151a for further processing. The database can be a key-value (KV) database and store an associative array (e.g., a map, a dictionary) to represent data as a collection of key-value pairs. The saved data in the database can be made available to a party who is authorized to access a particular piece of data stored in the database.

According to one embodiment, the machine learning module 162, the input streaming module 164, and the stream processing module 165 of the machine learning device 151a can be implemented in software or firmware. The instructions of the software or the firmware can be stored in a local storage 166 and processed by a processor 167. The instructions of the software or the firmware can be updated from an external system or the machine learning device 151a internally. For example, the streaming processing module 115 can implement a facial recognition capability and generate and/or send trained results (e.g., facial images with tags) to other machine learning devices. Using the internal and decentralized machine learning module 162, the machine learning device 151a can generate its own learned results independently of other machine learning devices, or with reference to externally learned results from other machine learning devices. Instead of relying on a central server for data collection and centralized machine learning, the decentralized machine learning system 150 allows each of the machine learning devices 151 to independently as well as collectively learn and train themselves. Because the raw data does not need to be passed along to the central server, and only trained results can be exchanged among the machine learning device 151 for collective machine learning, the decentralized machine learning system 150 can reduce the data traffic while enhancing the efficiency of the overall system by decentralizing the machine learning at a device level and using the central machine learning for more useful and collective machine learning at a system level.

According to another embodiment, the machine learning module, 162, the input streaming module 164, and the stream processing module 165 of the machine learning device 151a can be implemented in hardware, and each of the hardware can have dedicated computing resources. For example, each processor in a multicore system can be configured to perform designated tasks for the input streaming module 164, and the stream processing module 165. In this case, the processors of the multicore system can communicate with each other via shared memory that is much more efficient than inter-process communication (IPC).

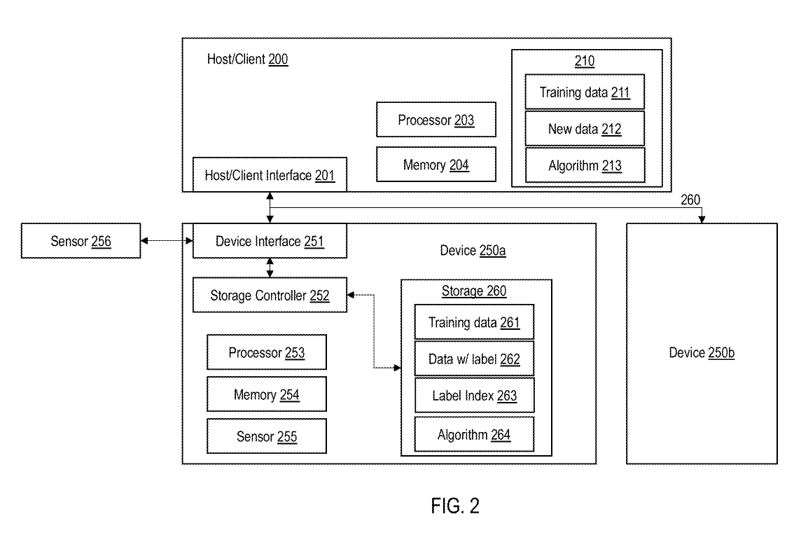

FIG. 2 shows a diagram of an example decentralized machine learning system, according to one embodiment. The decentralized machine learning system 200 can include one or more machine learning devices 250 (e.g., 250a and 250b) and one or more host/client computer 200. Although the present example shows only host/client computer 200 and two machine learning devices 250a and 250b, it is understood that any number of host/client computers and machine learning devices can be included in the decentralized machine learning system 200 without deviating from the scope of the present disclosure.

According to one embodiment, the machine learning devices 250a can include a device interface 251, a storage controller 252, a processor 253, and a memory 254. The processor 253 can perform machine learning based on the inputs from an embedded sensor 255 or an external sensor 256 attached to the machine learning device 250a. The processor 253 and the memory 254 of the machine learning devices 250a can track and maintain data internally and perform machine-learning activities more efficiently.

The storage controller 252 can control the access to and from storage 260 where self-learned data and algorithms for machine learning are stored. The storage 260 can include training data 261, data with a label 262, label index 263, and algorithms 264. The training data 261 can include data that are trained by the machine learning devices 250a (e.g., recognized faces in the case of a security camera). The data with label 262 can include data that the machine learning devices 250a labeled or tagged (e.g., images including tags). The label index 263 can include indices of the trained data. The training data 261, the data with label 262, and the label index 263 can collectively contain trained data, and the machine learning devices 250a can send the trained data to other devices (e.g., 250b) and/or the host/client computer 200. The algorithm 264 can include various algorithms that the machine learning devices 250a have learned on its own and/or received from other devices. The machine learning devices 250a can learn a new algorithm based on its own learning and on algorithms that other devices have learned and passed along. In some embodiments, the host/client computer 200 can learn algorithms based on the training data 261, the data with label 262, and the label index 263, and the algorithm 264 received from the connected devices 250 and send the new algorithms back to the devices 250.

According to one embodiment, the host/client computer 200 can include a device interface 201, a processor 203, a memory 204, and a pattern recognition component 210. The pattern recognition component 210 can include training data 211, new data 212, and algorithm(s) 213. The processor 203 can perform system-level machine learning based on the inputs from the attached machine learning devices 250. The processor 203 and the memory 204 of the host/client computer 200 can track and maintain training data 211 and new data 212 received from the attached machine learning devices 250, and generate new algorithm 213. Because the device processor 253 can have less overhead to track and maintain data internally, the host processor 203 can perform more useful and higher-level deep machine learning activities at a system-level. The machine learning devices 250 and the host/client computer 200 can communicate over any communication network 260 such as the Internet.

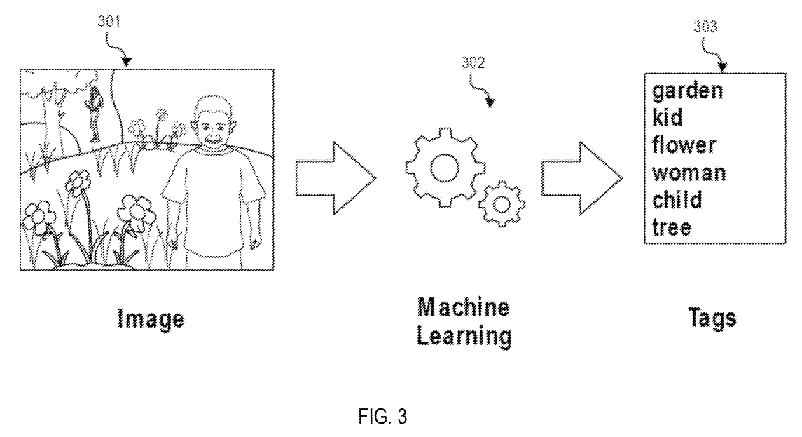

FIG. 3 shows an example of a decentralized machine learning process by the present machine learning device, according to one embodiment. In the present example, the present machine learning device includes a camera and can take images 301 and perform a local machine learning process 302. The machine learning process 302 can include pattern recognition, and image tagging based on the categories and identified objects in the pictures. In one embodiment, the present machine learning device can assign tags 303 (e.g., captioning/keywords) as metadata associated with the image 301. The present machine learning device can identify various captioning/keywords associated with image 301, and tag the image 301 with the tags 303 including, for example, garden, kid, flower, woman, child, tree, etc.

Another example of the decentralized machine learning process is a visual similarity search. The present machine learning device can use retrieved tags associated with processed images to search related images that relate to a search tag. The images that are tagged and searched may be located internally in a local storage of a particular machine learning device. In some embodiments, a machine learning device can perform a search by requesting other trusted machine learning devices to perform the same search locally and receiving the search results by the other trusted machine learning devices. In this case, the visual similarity search can be performed in a decentralized manner without an interruption by a host/client computer. The present machine learning device can perform automatic tagging on images that exist on the local storage or images that are provided by a user. In some embodiments, the automatic tagging can be initiated by an external machine learning device via a message as will be explained below in further details.

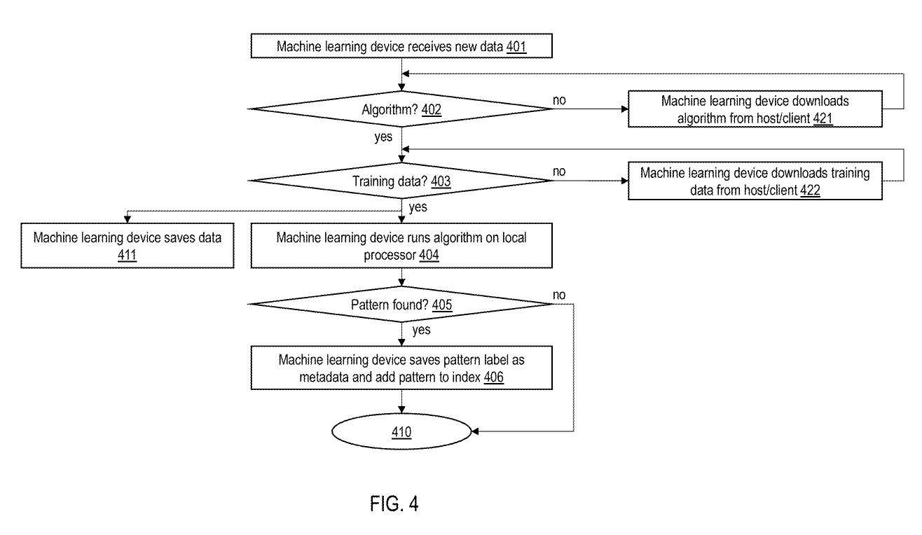

As shown above, the present machine learning device can be set as a storage repository for images, and can be given a machine learning task of applying tags to each image contained therein for easy future search and retrieval. In order to accomplish the machine learning task, the present machine learning device may be given an initial set of data to work on. Next, the present machine learning device can be directed to perform a designated task (e.g., tag images) by an outside agent (a host processor 203 of FIG. 2 or another machine learning device). If the present machine learning device does not already have an algorithm to perform the designated task, the present machine learning device can download a specified algorithm from a known location, for example, algorithm data 213 of the host/client computer 200 shown in FIG. 2. Likewise, if the present machine learning device does not already have training data associated with the specified algorithm, the present machine learning device can download a specified training data from a known location as well, for example, training data 211 of the host/client computer 200 shown in FIG. 2. The present machine learning device can then run the algorithm on the data using its own processor 253 shown in FIG. 2. In this case, the local processor 253 of the present machine learning device can train on the sample data, and then tag the working data (e.g., images). The tags and/or tagged images can be optionally exported to an external party (e.g., other machine learning devices or the host/client computer), or locally stored in the present machine learning device for retrieval later. The examples of the processes for these decentralized machine learning activities are shown with reference to FIGS. 4-6.

FIG. 4 is an example flowchart for processing new data, according to one embodiment. The present machine learning device receives new data (step 401) and determines whether an algorithm for processing the new data is available (step 402). If the algorithm is not available, the present machine learning device can download the algorithm from a host/client computer (step 421). If the algorithm is internally available, the present machine learning device further determines training data for processing the new data is available (step 403). The steps 401, 402, and 403 (and additionally steps 421 and 422) can be performed in different orders or independently from each other. For example, the present machine learning device can first determine an algorithm and training data associated with the algorithm, download the algorithm and training data if they are not internally available, and then receive the new data. It is noted that a different sequence of performing the steps 401, 402, and 403 (and 421 and 422 if applicable) can be employed without deviating from the scope of the present disclosure. If the training data is not available, the present machine learning device can download the training data from the host/client computer (step 422). Referring to FIG. 2, the algorithm 213 and training data 211 can be stored in the pattern recognition component 210 of the host/client computer 200 for retrieval by the machine learning device 251.

The present machine learning device can save new data in the local storage (step 411) and apply the algorithm to the new data using the local processor (step 404). The present machine learning device can determine whether a pattern is found from the new data (step 405). If the pattern is found from the new data, the present machine learning device can save the data along with a pattern label 262 as metadata and add the found pattern to the label index 263 (step 406) in the local storage 260. After running the algorithm and performing a pattern finding on the new data, the present machine learning system completes the processing on the new data (step 410).

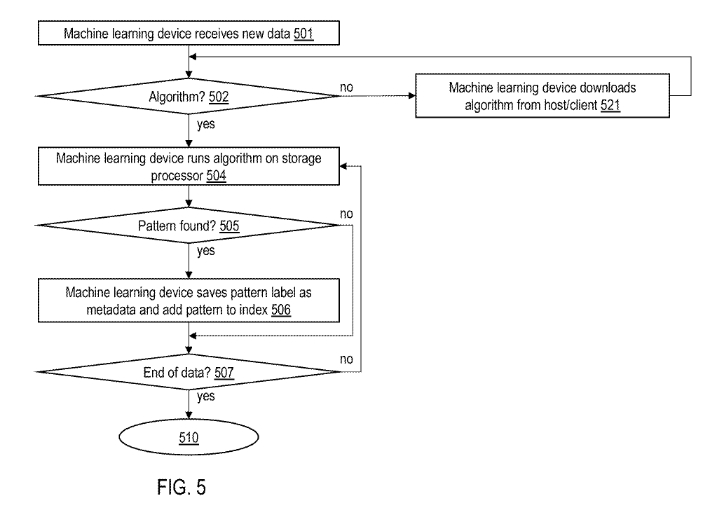

FIG. 5 is an example flowchart for processing new updated training data, according to one embodiment. The present machine learning device receives new data (step 501) and determines whether an algorithm for processing the new data is available (step 502). If the algorithm is not available, the present machine learning device can download the algorithm from a host/client computer (step 521). The steps 501 and 502 (and additionally step 521) can be performed in different orders or independently from each other. For example, the present machine learning device can first determine an algorithm to apply (step 502), download the algorithm if it is not internally available (step 521), and then receive a new data (step 501). It is noted that a different sequence of performing the steps 501 and 502 (and 521 if applicable) can be employed without deviating from the scope of the present disclosure. Once the algorithm becomes available, the present machine learning device can run the algorithm on the local processor (step 504). The present machine learning device can determine whether a pattern is found from the new data (step 505). If the pattern is found from the new data, the present machine learning device can save the data along with a pattern label 262 as metadata and add the found pattern to the label index 263 (step 506) in the local storage 260. The present machine learning device can further determine whether there is more data to process on and run the algorithm on the additional data (steps 504-507) until there is no more data to process on using the selected algorithm. After running the algorithm and performing a pattern finding on the new data, the present machine learning system completes the processing on the new updated training data (step 510).

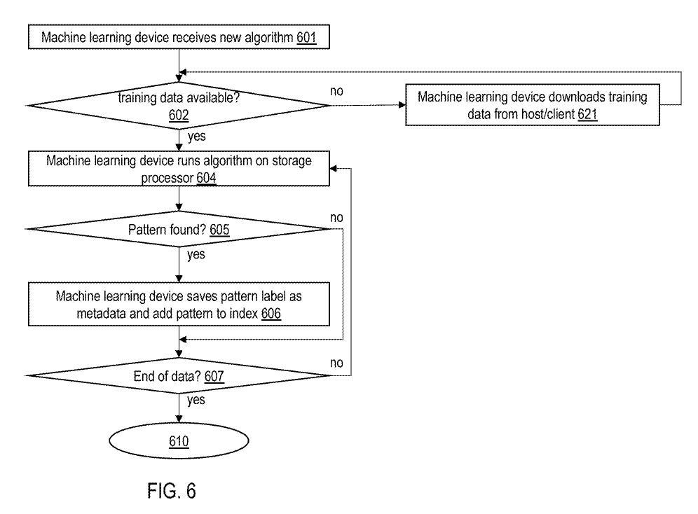

FIG. 6 is an example flowchart for processing new algorithm, according to one embodiment. The present machine learning device receives new algorithm from other machine learning devices or a host/client computer (step 601) and determines whether it has training data on its local storage (step 602). If the training data is not available, the present machine learning device can download the training data from a host/client computer (step 621). The steps 601 and 602 (and additionally step 621) can be performed in different orders or independently from each other. For example, the present machine learning device can first determine whether a training data is available (step 601), download the algorithm if it is not internally available (step 621), and then receive a new algorithm (step 601). It is noted that a different sequence of performing the steps 601 and 602 (and 621 if applicable) can be employed without deviating from the scope of the present disclosure. Once the training data becomes available, the present machine learning device can run the new algorithm on the local processor (step 604). The present machine learning device can determine whether a pattern is found from the training data using the new algorithm (step 605). If the pattern is found from the new data, the present machine learning device can save the data along with a pattern label 262 as metadata and add the found pattern to the label index 263 (step 606) in the local storage 260. The present machine learning device can further determine whether there is more data to process on and run the algorithm on the additional data (steps 604-607) until there is no more data to process on using the selected algorithm. After running the algorithm and performing a pattern finding on the new data, the present machine learning system completes the processing the new algorithm (step 610).

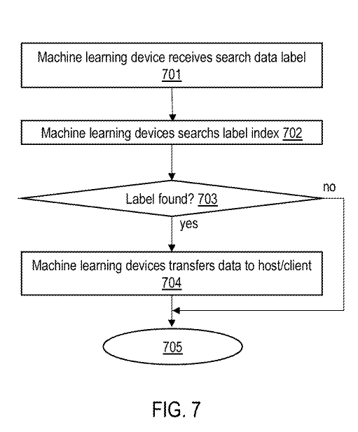

FIG. 7 is an example flowchart for data search, according to one embodiment. The present machine learning device receives a search data label from a search requester, for example, a host/client computer or another machine learning device (step 701). In one embodiment, the search data label may be broadcast to more than one machine learning devices in the decentralized machine learning system. The present machine learning device can search the local search label index 263 (step 702). If the search data label is found (step 703), the present machine learning device transfers the associated data to the search requester (step 704). After searching the label index and transferring data to the host/client, the present machine learning system completes the data search (step 705).

As mentioned previously, the present machine learning device is capable of locally performing machine learning activities and coordinating collective machine learning activities in conjunction with other machine learning devices having the same or similar decentralized machine learning capabilities without an active intervention of a host/client computer. The host/client computer can receive locally trained data from multiple machine learning devices and perform more useful and higher-level deep machine learning activities.

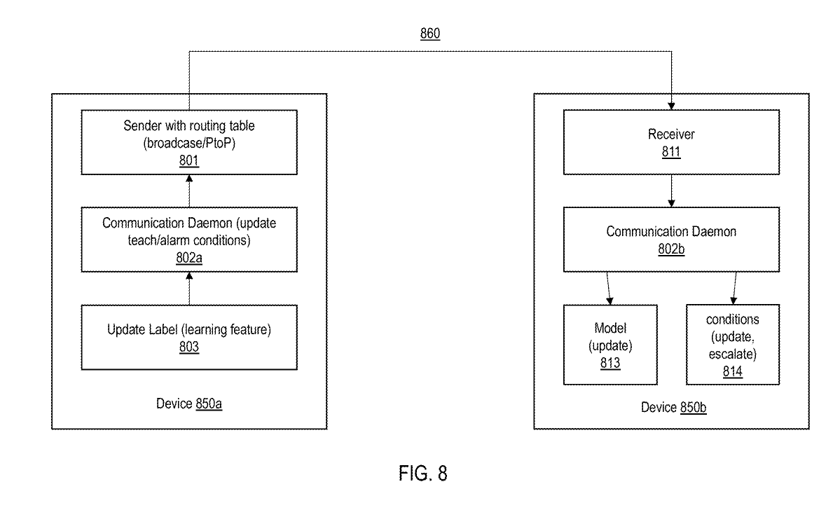

FIG. 8 is an example diagram explaining communication between storage devices, according to one embodiment. Each of the machine learning devices 850a and 850b can have a sender 801, a communication daemon 802, an update label module 803, a receiver 811, and a storage for a model 813 and conditions 814. In the present example, a first machine learning device 850a and a second machine learning device 850b , m are shown to have different components and functional modules therein, however it is understood that the first machine learning device 850a and the second machine learning device 850b can have the similar/identical components and functional modules. For example, both the first machine learning device 850a and the second machine learning device 850b can include a sender 801, a communication daemon 802, an update label module 803, a receiver 811, and a storage for a model 813 and conditions 814. In the present example, the first machine learning device 850a can act as a sender while the second machine learning device 850b can act as a receiver, therefore the first machine learning device 850a and the second machine learning device 850b are shown to include only those components that are relevant to their roles. However, it is noted that both machine learning devices 850a and 850b can further include other common and/or shared components for performing their intended activities.

The first machine learning device 850a can have an updated label 803 based on learned features after processing locally generated data and performing machine learning thereon. The first machine learning device 850a can prepare to send a message based on the updated label 803 to other machine learning devices via the communications daemon 802a. The message can include updated teach and alarm conditions. Using the sender 801, the communications daemon 802a can send the message to a receiver of a second machine learning device 850b. The first machine learning device 850a can broadcast the message to other machine learning devices or send the message to a designated machine learning device (e.g., 850b) via a point-to-point protocol.

The second machine learning device 850b can receive the message (either by receiving broadcast message or point-to-point message) using the receiver 811. The receiver 811 can forward the received message to the communication daemon 802b. The communication daemon 802b can determine whether the received message includes a teach case or an alarm case. The teach case can be used to update the model 813, and the alarm case can be used to update the alarm condition 814 locally or escalate the alarm condition 814 to other machine learning devices and/or a host/client computer (not shown).

Each of the machine-learning devices 850a and 850b can locally run a communication daemon 802 as an independent service to provide a native capability to compose and communicate messages to other fellow machine learning devices over their communication interfaces including the sender 801 and the receiver 811. In some embodiments, the message communication can utilize a host-allocated communications port. Thus, when an important event occurs on one machine learning device, the information can be shared with other machine learning devices via the host-allocated communications port.

For example, if the first machine learning device 850a, while performing image recognition and tagging, learns a new feature, the first machine learning device 850a can share its updated learning model with other machine learning devices that can be tasked with the same or similar image recognition and tagging tasks based on the newly learned feature by the first machine learning device 850a. Likewise, if the first machine learning device 850a experiences an error or an alarm case, the first machine learning device 850a can transmit messages indicating such circumstances to other machine learning devices to allow them to respond to the error or the alarm case accordingly.

According to one embodiment, the control of communication and learning can be through a node allow table that is initialized when a new service is started. The node allow table can be updated in a decentralized manner, for example, being propagated via trusted nodes of machine learning devices.

Furthermore, the node allow table can be used to track learning settings. In one embodiment, a learning rate of a machine learning device can be set from a remote host/client computer. For example, the learning rate can have a range from 0 to 1, 0 indicating the machine learning device never learns and 1 indicating the machine learning device always learns. In another embodiment, an update rate of a machine learning device can also be set from the remote host/client computer. The update rate can be used to control how often a machine learning device can broadcast updates to its learning model. For example, an update rate of 0 means that the machine learning device never updates features to a remote node, and an update rate of 1 means that the machine learning device always broadcast.

According to one embodiment, the present disclosure provides a decentralized machine learning scheme using smart devices. The smart devices can learn and update machine learning models. For example, the machine learning model includes image data with tags assigned thereto. The smart devices can further teach other smart devices and exchange updated models according to their relationship. Some smart devices can only update other trusted smart devices whereas other smart devices can only receive updated models from their trusted smart devices.

According to one embodiment, the smart devices can have various features associated with decentralized machine learning. For example, the smart devices can support new vendor commands such as LEARN, ML_EXCHANGE, are SEARCH. The command LEARN can be assigned to input stream with metadata for machine learning algorithm and features. The command ML_EXCHANGE can be used to provide arguments with peers and policy. The command SEARCH can be used with given event or data search local database and/or fellow smart devices. The smart devices can further support new application programming interfaces (APIs) for the vendor commands. The smart devices can initiate new services for the commands using the APIs. The smart devices can further support the storage interfaces for the commands, APIs, and services.

According to one embodiment, a storage device can include a processor, a storage and a communication interface. The storage is configure to store local data and a first set of machine learning instructions, and the processor is configured to perform machine learning on the local data using the first set of machine learning instructions and generate and/or update a machine learning model after performing the machine learning on the local data. The communication interface is configured to send an update message including the generated or updated machine learning model to other storage devices.

The communication interface can be further configured to receive a second update message from another storage device and perform the machine learning on the local data using the second update message.

The storage device can further include a communication daemon for preparing a first updated message to send to a first storage device and processing a second updated message received from a second storage device.

The storage device can include a camera, the local data can include images taken by the camera, and the machine learning model can include tags associated with the images.

The storage device can include one or more of a heartrate sensor, a pedometer sensor, an accelerometer, a glucose sensor, a temperature sensor, a humidity sensor, and an occupancy sensor.

The communication interface can be further configured to send the update message including the generated or updated machine learning model to a server, and the server can be configured to perform deep learning using a plurality of update machine learning models received from a plurality of storage devices.

The communication interface can be further configured to receive training data from a second storage device.

The communication interface can be further configured to receive a second set of machine learning instructions from a second storage device, and the processor can be further configured to perform the machine learning on the local data using the training data and the second set of machine learning instructions.

The processor can be further configured to perform the machine learning, identify a pattern on the local data, and save a pattern label as metadata associated with the local data, and add the pattern label to a label index.

The communication interface can be further configured to receive a search data label, search the label index that matches with the search data label, and send associated data with the label index to a server.

The storage can be further configured to store the machine learning model and alarms generated based on the local data.

According to one embodiment, a method can include: storing local data and a first set of machine learning instructions in a storage device; performing machine learning on the local data using the first set of machine learning instructions; generating and updating a machine learning model; and sending an update message including the generated or updated machine learning model to other storage devices.

The method can further include receiving a second update message from another storage device and performing the machine learning on the local data using the second update message.

The method can further include preparing a first updated message to send to a first storage device and processing a second updated message received from a second storage device.

The storage device can include a camera, the local data can include images taken by the camera, and the machine learning model can include tags associated with the images.

The storage device can be a smart watch comprising one or more of a heartrate sensor, a pedometer sensor, an accelerometer, a glucose sensor, a temperature sensor, a humidity sensor, and an occupancy sensor.

The method can further include: sending the update message including the generated or updated machine learning model to a server; and performing at a server deep learning using a plurality of update machine learning models received from a plurality of storage devices.

The method can further include receiving training data from a second storage device.

The method can further include: receiving a second set of machine learning instructions from a second storage device; and performing the machine learning on the local data using the training data and the second set of machine learning instructions.

The method can further include: performing the machine learning, identify a pattern on the local data; saving a pattern label as metadata associated with the local data; and adding the pattern label to a label index.

The method can further include: receiving a search data label; searching the label index that matches with the search data label; and sending associated data with the label index to a server.

The method can further include storing the machine learning model and alarms generated based on the local data.

The above example embodiments have been described hereinabove to illustrate various embodiments of implementing an in-storage computing apparatus and method for decentralized machine learning. Various modifications and departures from the disclosed example embodiments will occur to those having ordinary skill in the art. The subject matter that is intended to be within the scope of the present disclosure is set forth in the following claims.

What is claimed is:

1. A storage device comprising:
a processor;
a storage configured to store local data and a first set of machine learning instructions, wherein the processor is configured to perform machine learning on the local data using the first set of machine learning instructions and generate or update a machine learning model after performing the machine learning on the local data;
and
a communication interface configured to send an update message including the generated or updated machine learning model to other storage devices.

2. The storage device of claim 1, wherein the communication interface is further configured to receive a second update message from another storage device and perform the machine learning on the local data using the second update message.

3. The storage device of claim 1, further comprising a communication daemon for preparing a first updated message to send to a first storage device and processing a second updated message received from a second storage device.

4. The storage device of claim 1, wherein the storage device includes a camera, and the local data includes images taken by the camera, and wherein the machine learning model includes tags associated with the images.

5. The storage device of claim 1, wherein the storage device comprises one or more of a heartrate sensor, a pedometer sensor, an accelerometer, a glucose sensor, a temperature sensor, a humidity sensor, and an occupancy sensor.

6. The storage device of claim 1, wherein the storage device includes one or more of a temperature sensor, a humidity sensor, and an occupancy sensor.

7. The storage device of claim 1, wherein the communication interface is further configured to send the update message including the generated or updated machine learning model to a server, and the server is configured to perform deep learning using a plurality of update machine learning models received from a plurality of storage devices.

8. The storage device of claim 1, wherein the communication interface is further configured to receive training data from a second storage device.

9. The storage device of claim 8, wherein the communication interface is further configured to receive a second set of machine learning instructions from a second storage device, and wherein the processor is further configured to perform the machine learning on the local data using the training data and the second set of machine learning instructions.

10. The storage device of claim 1, wherein the processor is further configured to perform the machine learning, identify a pattern on the local data, and save a pattern label as metadata associated with the local data, and add the pattern label to a label index.

11. The storage device of claim 10, wherein the communication interface is further configured to receive a search data label, search the label index that matches with the search data label, and send associated data with the label index to a server.

12. The storage device of claim 1, wherein the storage is further configured to store the machine learning model and alarms generated based on the local data.

13. A method comprising:
storing local data and a first set of machine learning instructions in a storage device;
performing machine learning on the local data using the first set of machine learning instructions;
generating and updating a machine learning model; and
sending an update message including the generated or updated machine learning model to other storage devices.

14. The method of claim 13, further comprising receiving a second update message from another storage device and performing the machine learning on the local data using the second update message.

15. The method of claim 13, further comprising preparing a first updated message to send to a first storage device and processing a second updated message received from a second storage device.

16. The method of claim 13, wherein the storage device includes a camera, and the local data includes images taken by the camera, and wherein the machine learning model includes tags associated with the images.

17. The method of claim 13, wherein the storage device comprises one or more of a heartrate sensor, a pedometer sensor, an accelerometer, a glucose sensor, a temperature sensor, a humidity sensor, and an occupancy sensor.

18. The method of claim 13, wherein the storage device includes one or more of a temperature sensor, a humidity sensor, and an occupancy sensor.

19. The method of claim 13, further comprising:
sending the update message including the generated or updated machine learning model to a server; and
performing at a server deep learning using a plurality of update machine learning models received from a plurality of storage devices.

20. The method of claim 13, further comprising receiving training data from a second storage device.

21. The method of claim 20, further comprising:
receiving a second set of machine learning instructions from a second storage device; and
performing the machine learning on the local data using the training data and the second set of machine learning instructions.

22. The method of claim 13, further comprising:
performing the machine learning, identify a pattern on the local data;
saving a pattern label as metadata associated with the local data; and
adding the pattern label to a label index.

23. The method of claim 22, further comprising:
receiving a search data label;
searching the label index that matches with the search data label; and
sending associated data with the label index to a server.

24. The method of claim 13, further comprising storing the machine learning model and alarms generated based on the local data.
